(19) United States
(12) Patent Application Publication
(10) Pub. No.: US 2026/0329452 A1
(43) Pub. Date: Oct. 22, 2026

(54) GLOBAL RAS DECISION AND DVFS ALLOCATOR WITH PER DIE MONITORS AND CONTROLLERS IN CHIPLET ARCHITECTURES

(71) Applicant: Samsung Electronics Co., Ltd., Gyeonggi-do (KR)

(72) Inventor: Xiao SUN, Austin, TX (US)

(21) Appl. No.: 19/313,476

(22) Filed: Aug. 28, 2025

Related U.S. Application Data
(60) Provisional application No. 63/790,455, filed on Apr. 17, 2025.

(51) Int. Cl. G06F 3/06; G06F 9/50

(52) U.S. Cl. CPC G06F 3/0616; G06F 3/0634; G06F 3/0679; G06F 9/5066; G06F 2209/501

(57) ABSTRACT

A method and system for managing dynamic voltage/frequency scaling (DVFS) and aging in chiplet-based system on integrated circuit (SoIC) architectures are disclosed. The method involves resetting multiple dies upon power-up, each equipped with local DVFS controllers and monitors to measure operating parameters such as voltage, temperature, and workload indicators. A global DVFS allocator receives performance data from the local monitors, adjusts DVFS credit allocations based on a calibrated global DVFS policy, and communicates power shifting instructions to the local controllers. Aging uniformity is managed by a global reliability, availability, and serviceability (RAS) controller, which retrieves historical aging data from retention memory and applies adjustments to optimize system reliability. The system includes a global DVFS allocator, a global RAS controller, and retention memory for storing operational parameters and aging data. This approach enhances performance, reliability, and resource allocation in semiconductor technologies, particularly for SoIC architectures.

### CROSS-REFERENCE TO RELATED APPLICATION

This application claims the priority benefit under 35 U.S.C. § 119(e) of U.S. Provisional Application No. 63/790,455, filed on Apr. 17, 2025, the disclosure of which is incorporated by reference in its entirety as if fully set forth herein.

### TECHNICAL FIELD

The disclosure generally relates to semiconductor technologies. More particularly, the subject matter disclosed herein relates to improvements to chiplet-based system-on-integrated-circuit (SoIC) architectures incorporating global power management and reliability systems for enhancing performance, addressing aging, and managing resource allocation across multiple dies.

### SUMMARY

In chiplets or SoICs, different dies can be made from different manufacturing nodes. Some dies may come from the same manufacturing node X and other dies may come from the same manufacturing node Y. Even when the dies are built using the same manufacturing node and contain identical transistors, variations in electrical characteristics, performance and power can still occur due to process variations.

Each die should be tested independently, its speed and leakage characteristics should be saved for binning purposes. These characteristics are eventually fused on the die.

In a single die system on chip (SoC), components such as a reliability, availability, and serviceability (RAS) controller (e.g., an aging controller), a dynamic voltage/frequency scaling (DVFS) controller, and monitors for voltage, temperature, and frequency, as well as speed and leakage information, are fused on the same die.

In chiplet architecture, it is natural to have the RAS controller, DVFS controller, and monitors for voltage, temperature, and frequency, as well as speed and leakage information, fused on the each die. However, this lacks a global power budget allocator, as well as a global aging decision maker and provision issuer.

However, if there is a global decision maker and provision issuer and power budget allocator, this introduces a complex challenge.

When scaling a single SOC (whether a monolithic or chiplet-based SoIC architecture) to a cluster of SOCs to handle a computing or processing workload, each silicon die exhibits its own speed, leakage and volage/frequency (VF) curve characteristics. Additionally, large-scale system cooling is not uniformly distributed for each individual die or SoIC, leading to temperature inconsistencies at the package level. As a result, cluster level performance is slowed by the slowest die or SoIC of the entire system. This represents another challenge.

Furthermore, with many dies or SoICs in a cluster, the RAS controller has a role to mitigate lower mean time failure (MTF) of a cluster proactively. This represents yet another challenge.

To overcome these issues, systems and methods are described herein for managing DVFS and aging in a chiplet-based SoIC architecture.

According to an embodiment, a SoIC architecture is provided with a centralized DVFS allocator and RAS controller with distributed local DFVS controllers and monitors on each die to address the need to balance aging uniformity such that the overall system is aging gracefully to achieve longevity of the overall system as well as availability.

Accordingly, overall system RAS is enhanced as follows: Reliability is improved through aging-based adjustments using local die information, but guided by SoIC level and/or system level decisions; Availability is increased by proactively improving the availability of all units, e.g., by shortening tasks on the critical path; and Serviceability is achieved by proactively identifying and removing SoICs that fall outside of acceptable specification ranges.

In one embodiment, a method is provided for managing dynamic voltage/frequency scaling (DVFS) and aging in a chiplet-based SoIC architecture, comprising: resetting, upon power-up, a plurality of dies in the SoIC, each die including a local DVFS controller and local monitors configured to measure voltage, temperature, frequency, speed, leakage, and workload indicators; receiving, at a global DVFS allocator, performance data from the local monitors of each die, the performance data including front-end performance counters and back-end loading indicators; adjusting, by the global DVFS allocator, DVFS credit allocations for the dies based on a calibrated global DVFS policy derived from the received performance data; communicating, from the global DVFS allocator, power shifting instructions to the local DVFS controllers associated with the dies; and managing aging uniformity by retrieving historical aging data stored in a retention memory and applying, by a global RAS controller operating in cooperation with the global DVFS allocator, aging adjustments to optimize reliability and availability across the SoIC, wherein the aging adjustment are applied to minimize unexpected failures from aging. In some embodiments, the method of the present disclosures ensures silicon reliability and availability across a product's lifecycle.

In one embodiment, a system is provided for managing DVFS and aging in a chiplet-based SoIC architecture, comprising: a plurality of dies, each die including: a local DVFS controller configured to adjust DVFS operations for the die; and local monitors configured to measure operating parameters of the die, the operating parameters including voltage, temperature, frequency, speed, leakage, and workload indicators; a global DVFS allocator operatively coupled to the plurality of dies, the global DVFS allocator configured to: receive performance data from the local monitors of the dies, the performance data including front-end performance counters and back-end loading indicators; determine DVFS credit adjustments for the dies based on a calibrated global DVFS policy derived from the performance data; and issue power shifting and power gating instructions to the local DVFS controllers; a global RAS controller operatively coupled to the global DVFS allocator and the plurality of dies, the global RAS controller configured to: retrieve historical aging data from a retention memory; and apply aging adjustments to the dies based on the retrieved historical aging data to manage aging uniformity; and the retention memory configured to store historical aging information and updated operational parameters for the dies; and wherein the global DVFS allocator and the global RAS controller cooperate to optimize system reliability, availability, and overall performance of the chiplet-based SoIC architecture.

### BRIEF DESCRIPTION OF THE DRAWING

In the following section, the aspects of the subject matter disclosed herein will be described with reference to exemplary embodiments illustrated in the figures, in which:

FIG. 1 shows a centralized connection SoIC architecture, according to an embodiment;

FIG. 2 shows a star tree structure connection SoIC architecture with M branches, according to an embodiment;

FIG. 3 shows a daisy chain connection SoIC architecture, according to an embodiment;

FIG. 4 is a flow chart illustrating a method for managing dynamic voltage/frequency scaling (DVFS) and aging in a chiplet-based SoIC architecture, according to one embodiment;

FIG. 5 is a block diagram of an electronic device in a network environment, according to an embodiment; and

FIG. 6 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” and/or “allocator” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules and/or allocators may, collectively or individually, be embodied as circuitry that forms part of a larger system, for example, but not limited to, an integrated circuit (IC), system on-a-chip (SoC), an assembly, and so forth.

In chiplet-based SoIC architectures, multiple dies, potentially from different manufacturing processes, are combined into a single package. These dies can exhibit variations in electrical characteristics such as speed, leakage, and power consumption, even when fabricated using the same technology. This non-uniformity introduces challenges in testing, monitoring, and managing system performance and reliability at both the die and system levels.

Systems and methods are described herein for managing dynamic voltage/frequency scaling (DVFS) and aging in a chiplet-based System on Integrated Chip (SoIC) architecture. According to an embodiment, a SoIC architecture is provided with a centralized DVFS allocator and RAS controller with distributed local DFVS controllers and monitors on each die to address the need to balance aging uniformity such that the overall system is aging gracefully to achieve longevity of the overall system as well as availability.

According to an embodiment, a global DVFS power management allocator gives the decision to a local DVFS controller on a particular die to shift power among dies in SoIC chiplets or among chiplet clusters (systems) with workload indications and each die's parameters (for example: from front end performance counters, from back end of performance counters, die speed, and leakage). After a reset, all dies in the SoIC will have the same DFVS credit, then the global DFVS allocator would adjust the credit of each die to the proper level according to the calibrated global DVFS policy. Local monitors then give a new credit allocation to each of the dies.

Front end of performance counters may include instructions committed decoding or work residency percentage and dispatching rate or at system level—software workload dispatched; while a backend indicator may include a percentage of loading to indicate waiting for new work by a processing subsystem chiplet. Front end of workload indicators may be viewed as new work receiving rate while the backend workload indicator may be viewed as work completion rate. When they are balanced, the SoIC would have maximum throughput; if front end indicator is increasing, but backend of indicator is not increasing them then the SoIC is bottlenecked with too much work. If the front end of indicator is reduced but the backend of indicator stays the same or reduced, then the SoIC is waiting for more work to be received. Combining both front and back-end indicators give an indication that the processing engine has less than capable work (i.e., hungry for more work) or more than capable work (i.e., over capacity) for the global DVFS allocator to make a decision based upon these workload indicators as well as each die's local monitors such that a particular die based DVFS controller would take proper actions.

Each die has its own DVFS controller but the global DVFS allocator would control power shift among chiplets and power gating between die interfaces within a single SoIC or system with many SoICs. Global resource management is critical for overall system throughput as the slowest unit of large scale would determine overall work completion time. Therefore, the global DVFS allocator needs to be aware of both the local die's situation and overall dependency to remove any bottlenecks important for overall system throughput. Aging uniformity needs to be balanced such that the overall system is aging gracefully, i.e., minimizing unexpected failures from aging, to achieve longevity of the overall system as well as always availability. By implementing aging uniformity among the dies, the system and method of the present disclosure ensures SoIC reliability and availability across the product's lifecycle in some embodiments. Long duration of over frequency and over voltage of a die can age the die. Since the global DVFS allocator works with a global RAS controller (proactively manage aging) together, this can be accomplished in several ways. For example, for client devices which boot/restart often, applying aging adjustment based upon past usage history is conducted at reboot or restart time and aging history needs to be saved in either retention memory or flash memory. As another example, for server devices which do not boot/restart often, the global RAS controller would apply an aging (including MTF to take the SoIC offline if aged beyond requirement for MTF needed) provision and adjust gradually via the global DVFS allocator during die/SoIC idle period. The current aging information for all dies in SoIC shall be stored in retention memory such that the global RAS controller can retrieve past information at restart if a particular server is lost power or shut down for service.

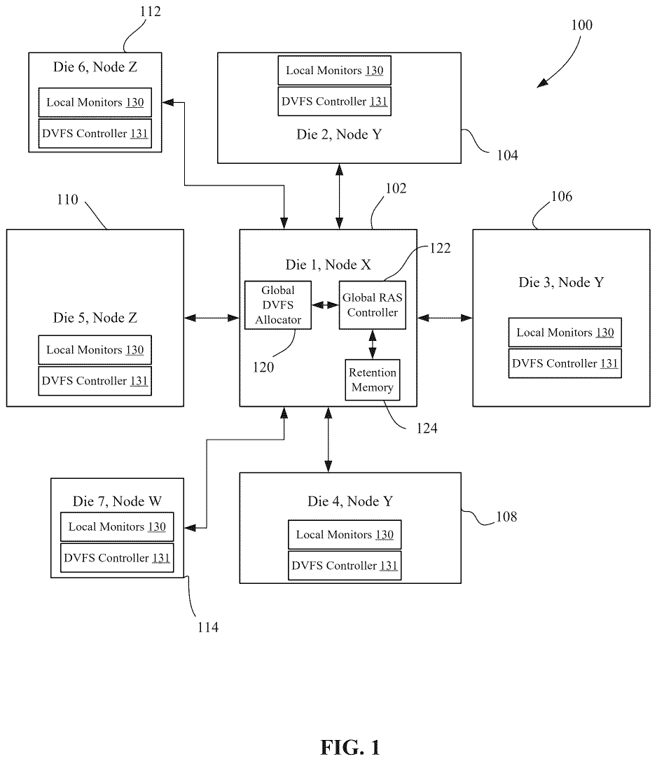

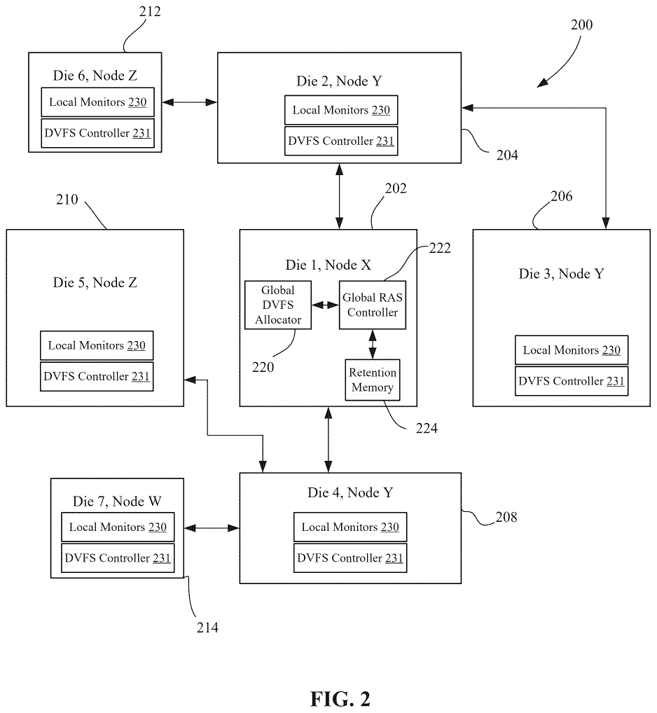

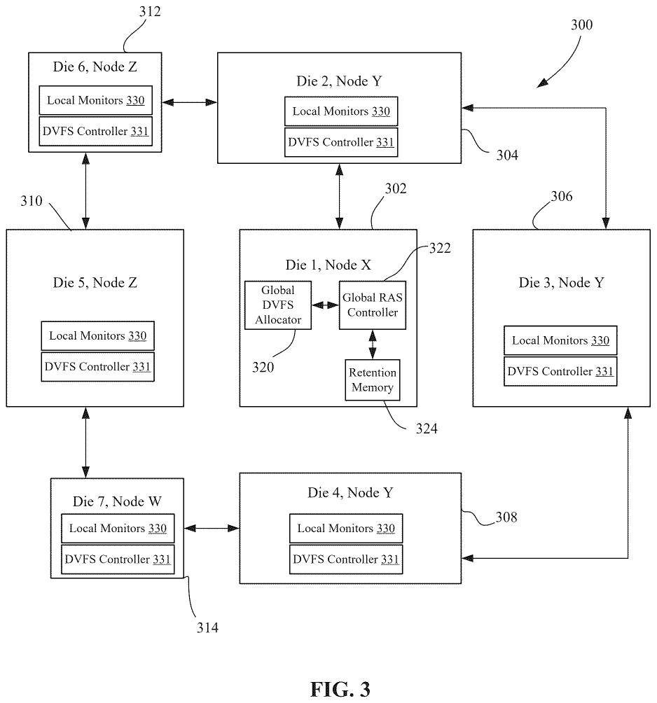

Three examples of chiplet SoIC architecture in accordance with the present disclosure are illustrated in FIG. 1, FIG. 2 and FIG. 3. Herein, it is assumed that different dies are in different manufacturing nodes which can exist in any combination. As will become apparent below, the interconnect between dies may be optimized to reduce latency and/or connection points.

FIG. 1 shows a centralized (or star) connection SoIC architecture 100 where Die1 102 is centralized to connect to all other dies in the SoIC 100, for example, Die2 104, Die3 106, Die4 108, Die5 110, Die6 112 and Die7 114.

In particular, FIG. 1 shows a global DVFS allocator and RAS decision controller with distributed local monitors and DVFS controllers (example of centralized die to die connection). Die1 102 includes a global DVFS allocator 120, a global RAS controller 122 and retention memory 124. Each of the remaining dies, Die2 104, Die3 106, Die4 108, Die5 110, Die6 112 and Die7 114, include local monitors 130 and a local DVFS controller 131. The advantage of this connection architecture is that only Die1 102 needs more connection points, the rest of the dies, e.g., Die2 104, Die3 106, Die4 108, Die5 110, Die6 112 and Die7 114, only have one connection point and the latency between the central Die1 102 with the global DVFS allocator 120 and RAS controller 122 to the rest of dies is shortest among the three examples. Die2-7 can be modular dies reused for other SoIC which have a different central die.

It is to be appreciated that although retention memory 124 is shown in Die1 102 the retention memory 124 may be disposed on a die other than the die that includes the global DVFS allocator 120 or may be disposed on another portion of the SoIC.

FIG. 2 shows a star tree structure architecture 200 with M (2 in the example) branches.

In particular, FIG. 2 shows a global DVFS allocator and RAS decision controller and with distributed local monitors and DVFS controllers combining two inter die connections, i.e., daisy chain two dies. Die1 202 includes a global DVFS allocator 220, a global RAS controller 222 and retention memory 224. Each of the remaining dies, Die2 204, Die3 206, Die4 208, Die5 210, Die6 212 and Die7 214, include local monitors 230 and a local DVFS controller 231. Here, Die1 202 has two connections: one connection to Die2 204 and one connection to Die4 208. Die2 204 and Die4 208 are then subsequently daisy chained to other dies, for example, Die2 204 is coupled to Die3 206 and Die6 212 and Die4 208 is coupled to Die5 210 and Die7 214. The SoIC connection architecture 200 of FIG. 2 increases latency to the depth of the tree (in FIG. 2, star span is 2, but that can be N), but the number of connections is two except the leaf on the branch end. When M equals 1 and M equals to total number of Dies-1, then the architecture becomes the same as shown in FIG. 1.

FIG. 3 shows daisy chain/ring connection SoIC architecture 300.

In particular, FIG. 3 shows a global DVFS allocator and RAS decision controller with distributed local monitors and DVFS controllers with daisy chain connections between distributed controllers and monitors. Die1 302 includes a global DVFS allocator 320, a global RAS controller 322 and retention memory 324. Each of the remaining dies, Die2 304, Die3 306, Die4 308, Die5 310, Die6 312 and Die7 314, include local monitors 330 and a local DVFS controller 331. Here, Die1 302 has one connection to Die 2 304 and Die 2 304 is then subsequently daisy chained to the remaining dies, for example, Die3 306, Die4 308, Die5 310, Die6 312 and Die7 314. The advantage of this is to reduce the inter die connection of the central allocator Die1 302 to 1, however the latency to the central die may not be uniform.

In an alternative embodiment, a central RAS controller 122 and DVFS allocator 120 could be implemented in software. However, software-based implementation might introduce latency between the time local die monitoring information is received and when the time global RAS decision and DVFS instructions are issued back to the local monitors and DVFS controller. For monolithic SOC, the DVFS and RAS controller can be implemented in Firmware of a local hardware controller in the same SOC.

It is to be appreciated that other die-to-die interconnect architectures are possible, for example, a tree topology have a predetermined number of branches, a mesh topology, a point-to-point topology, etc.

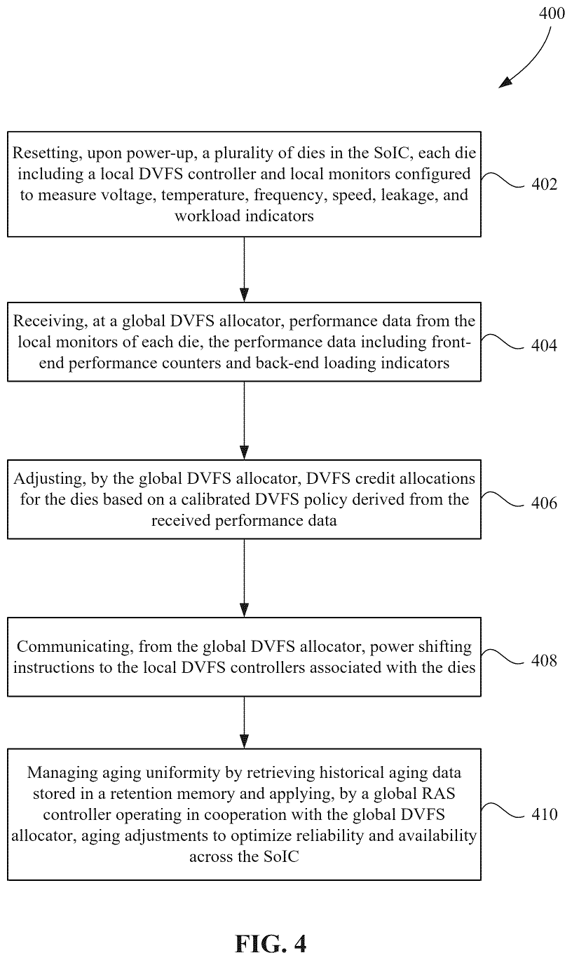

Referring to FIG. 4, a method 400 for managing dynamic voltage/frequency scaling (DVFS) and aging in a chiplet-based System on Integrated Chip (SoIC) architecture is provided. It is to be appreciated that although the method 400 will be described in conjunction with the architecture 100 shown in FIG. 1, the method 400 is equally applicable to the architecture 200, 300 shown in FIGS. 2 and 3.

In step 402, upon power-up, the plurality of dies, e.g., Die1 102, Die2 104, Die3 106, Die4 108, Die5 110, Die6 112 and Die7 114, in the SoIC 100 are reset. Each die includes a local DVFS controller 131 and local monitor 130 configured to measure voltage, temperature, frequency, speed, leakage, and workload indicators. It is to be appreciated that upon power-up, each of the plurality of dies is initially assigned an initial DVFS credit allocation prior to receiving adjustments based on a calibrated global DVFS policy, where the initial DVFS credit may be identical or not for each die. For example, a product has several operation points in terms of frequencies, then through platform level calibration with application regression to find a voltage needed to get applications running smoothly, this is called DVFS policy. Calibrated policy means the policy is calibrated with all silicon samples of the die needed to make sure the DVFS policy will not cause silicon failure or unexpected performance loss. Then, the calibrated global DVFS policy is a policy to guide how to shift power among or between dies.

In step 404, a global DVFS allocator 120 receives performance data from the local monitors 130 of each die, the performance data including front-end performance counters and back-end loading indicators. The performance data received from the local monitors may include at least front-end performance counters configured to measure instruction committed decoding and dispatching rates and back-end loading indicators configured to reflect processing subsystem utilization.

In step 404, the global DVFS allocator 120 adjusts DVFS credit allocations for the dies, e.g., Die2 104, Die3 106, Die4 108, Die5 110, Die6 112 and Die7 114, based on a calibrated global DVFS policy derived from the received performance data. The global DVFS allocator 120 determines the DVFS credit adjustments for each die by combining the front-end performance counters and the back-end loading indicators. It is to be appreciated that the DVFS policy is calibrated using process variation data associated with the electrical characteristics of each die. The global DVFS allocator 120 stores the adjusted DVFS credit allocations and updated aging information in the retention memory for use during subsequent power-up cycles.

In step 408, the global DVFS allocator 120 communicates power shifting instructions to the local DVFS controllers 131 associated with the dies via a die-to-die interconnect, e.g., star, star-tree, daisy chain, etc. Once the power shifting instructions are executed, then the local DVFS controller decreases part of the credit associated with the power shifting instructions, and the remaining credit can be used for local DVFS work. The global DVFS allocator 120, in cooperation with the global RAS controller 122, further communicates power gating instructions to the local DVFS controllers 131 to control power distribution among the dies.

In step 410, aging uniformity is managed by retrieving historical aging data stored in a retention memory 124 and applying, by a global RAS controller 122 operating in cooperation with the global DVFS allocator 120, aging adjustments to optimize reliability and availability across the SoIC, i.e., minimizing unexpected failures of dies from aging. In some embodiments, the managing aging uniformity ensures SoIC reliability and availability across a product's lifecycle. It is to be appreciated that the managing aging uniformity further includes retrieving historical aging data stored in the retention memory 124 and applying, by the global RAS controller 122, aging adjustments based on a predetermined mean time failure (MTF) threshold for each die. For example, after a chip or SoIC is running in the field for a while, it is aged. In order to keep the chip or SoIC in continued operation without failure, aging adjustments may be applied, such as a lower clock frequency or reduced voltage. How much aging adjustment is applied depends on the chip or SoIC being used in the field as well as reliability and availability requirement of end application. For example, enterprise and mission critical systems can require 99.999% of reliability and availability.

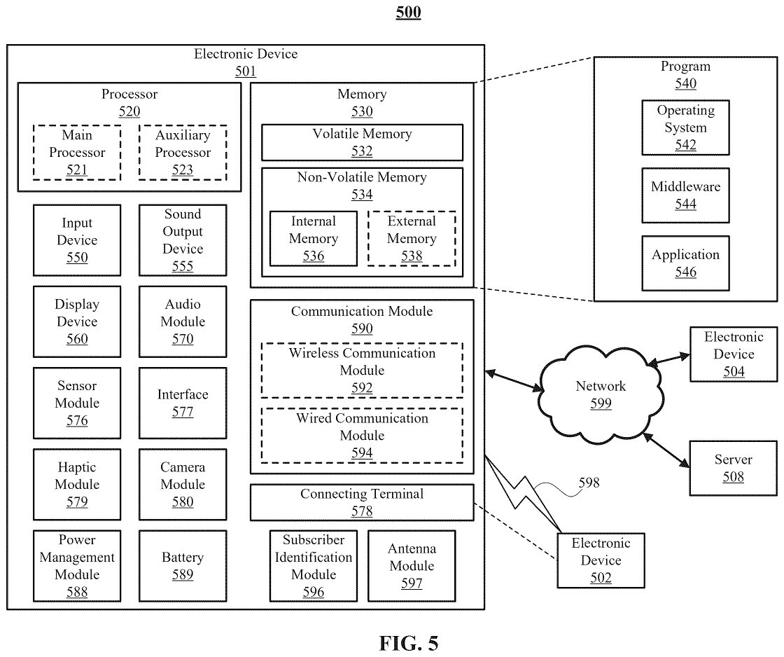

FIG. 5 is a block diagram of an electronic device in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

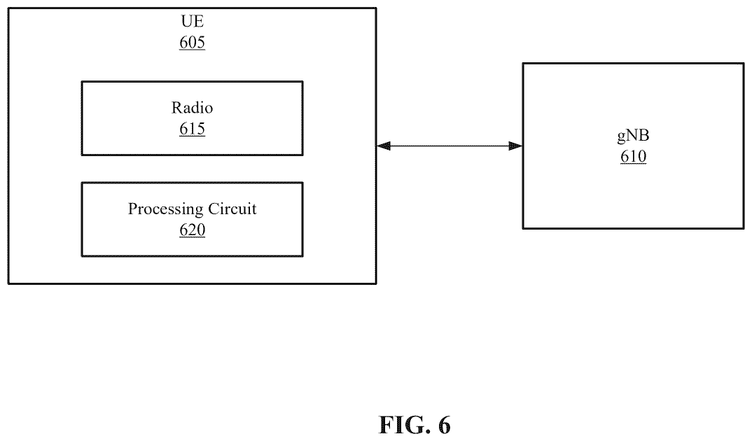

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 1. For example, the processing circuit 620 may receive, via the radio 615, transmissions from the network node (gNB) 610, and the processing circuit 620 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for managing dynamic voltage/frequency scaling (DVFS) and aging in a chiplet-based system on integrated circuit (SoIC) architecture, comprising:
resetting, upon power-up, a plurality of dies in the SoIC, each die including a local DVFS controller and local monitors configured to measure voltage, temperature, frequency, speed, leakage, and workload indicators;
receiving, at a global DVFS allocator, performance data from the local monitors of each die, the performance data including front-end performance counters and back-end loading indicators;
adjusting, by the global DVFS allocator, DVFS credit allocations for the dies based on a calibrated global DVFS policy derived from the received performance data;
communicating, from the global DVFS allocator, power shifting instructions to the local DVFS controllers associated with the dies; and
retrieving historical aging data of each die of the plurality of dies stored in a retention memory and applying, by a global RAS controller operating in cooperation with the global DVFS allocator, aging adjustments to each of the local DVFS controllers across the SoIC.

2. The method of claim 1, wherein upon power-up, each of the plurality of dies is initially assigned an initial DVFS credit allocation prior to receiving adjustments based on the calibrated global DVFS policy.

3. The method of claim 1, wherein the performance data received from the local monitors comprises: front-end performance counters configured to measure instruction committed decoding and dispatching rates; and back-end loading indicators configured to reflect processing subsystem utilization.

4. The method of claim 1, wherein the global DVFS allocator determines the DVFS credit adjustments for each die by combining the front-end performance counters and the back-end loading indicators.

5. The method of claim 1, further comprising calibrating the DVFS policy using process variation data associated with the electrical characteristics of each die.

6. The method of claim 1, wherein the aging adjustments are based on a predetermined mean time failure (MTF) threshold for each die.

7. The method of claim 1, further comprising storing the adjusted DVFS credit allocations and updated aging information in the retention memory for use during subsequent power-up cycles.

8. The method of claim 1, wherein the global DVFS allocator, in cooperation with the global RAS controller, further communicates power gating instructions to the local DVFS controllers to control power distribution among the dies.

9. The method of claim 1, wherein the global DVFS allocator communicates the power shifting instructions to the local DVFS controllers via a die-to-die interconnect within the SoIC.

10. A system for managing dynamic voltage/frequency scaling (DVFS) and aging in a chiplet-based system on integrated circuit (SoIC) architecture, comprising:
a plurality of dies, each die including:
a local DVFS controller configured to adjust DVFS operations for the die; and
local monitors configured to measure operating parameters of the die, the operating parameters including voltage, temperature, frequency, speed, leakage, and workload indicators;
a global DVFS allocator operatively coupled to the plurality of dies, the global DVFS allocator configured to:
receive performance data from the local monitors of the dies, the performance data including front-end performance counters and back-end loading indicators;
determine DVFS credit adjustments for the dies based on a calibrated global DVFS policy derived from the performance data; and
issue power shifting and power gating instructions to the local DVFS controllers;
a global RAS controller operatively coupled to the global DVFS allocator and the plurality of dies, the global RAS controller configured to:
retrieve historical aging data of each die of the plurality of dies from a retention memory; and
apply aging adjustments to the dies based on the retrieved historical aging data to manage aging uniformity of the plurality of dies; and
the retention memory configured to store historical aging information and updated operational parameters for the dies.

11. The system of claim 10, wherein upon power-up, each of the plurality of dies is initially assigned an initial DVFS credit allocation prior to receiving DVFS adjustments based on the calibrated global DVFS policy.

12. The system of claim 10, wherein the performance data received from the local monitors comprises front-end performance counters configured to measure instruction committed decoding and dispatching rates and back-end loading indicators configured to reflect processing subsystem utilization.

13. The system of claim 10, wherein the global DVFS allocator determines the DVFS credit adjustments for the dies by combining the front-end performance counters and the back-end loading indicators.

14. The system of claim 10, further comprising process variation data associated with the electrical characteristics of each die, wherein the global DVFS allocator calibrates the DVFS policy based on the process variation data.

15. The system of claim 10, wherein the global RAS controller applies aging adjustments to the dies based on a predetermined mean time failure (MTF) threshold for each die.

16. The system of claim 10, wherein the retention memory configured to store updated DVFS credit allocations and aging information for the dies, for use during subsequent power-up cycles.

17. The system of claim 10, wherein the global DVFS allocator and the global RAS controller cooperate to issue power gating instructions to control power distribution among the dies.

18. The system of claim 10, wherein the global DVFS allocator communicates power shifting instructions and power gating instructions, to the local DVFS controllers via a die-to-die interconnect within the SoIC.

19. The system of claim 18, wherein the die-to-die interconnect is a centralized die to die connection.

20. The system of claim 18, wherein the die-to-die interconnect is a star tree structure with a predetermined number of branches, each branch having a predetermined tree depth of dies.

21. The system of claim 18, wherein the die-to-die interconnect is a daisy chain connection between each of the plurality of dies.

22. The system of claim 18, wherein the die-to-die interconnect is a mesh connection between each of the plurality of dies.

23. The system of claim 18, wherein the die-to-die interconnect is a star tree structure with a predetermined number of branches, each branch having a predetermined tree depth of dies.
